(19) United States
(12) Patent Application Publication
(10) Pub. No.: US 2005/0114654 A1
(43) Pub. Date: May 26, 2005

(54) Method and apparatus for wireless biometric login

(76) Inventors: Charles Cameron Brackett, Overland Park, KS (US); Steven Lawrence Fors, Chicago, IL (US); Mark M. Morita, Arlington Heights, IL (US)

Correspondence Address: Patrick S. Yoder;FLETCHER YODER, P.O. Box 692289, Houston, TX, 77269-2289, US

(21) Appl. No.: 10/723,675

(22) Filed: Nov. 26, 2003

(51) Int. Cl. H04L 9/00

(52) U.S. Cl. 713/161

(57) ABSTRACT

A wireless device, such as a Bluetooth mobility pin is coupled to a biometric device, such as a thumb scanner, providing for wireless communication with a system to which access is desired. The thumb scanner provides a reliable and secure signal based upon biometric measurements, the signal being provided to the pin, which is then uniquely coded to the accessed system. When a workstation or other device having a compatible antenna receives the signal from the pin, the workstation accesses identification data and allows for login of the user based upon the highly secure biometric measurements, and the wireless connection between the pin and the system. The pin will not send the required code unless the coded user of the pin succeeds in scanning the thumbprint or other biometric measurement basis.

### BACKGROUND OF THE INVENTION

The present invention relates generally to the field of secure access systems, and more particularly to a technique for wirelessly and securely accessing a workstation based upon a biometric measurement.

Many fields require secure access to workstations, systems, and so forth based upon various login procedures. Passwords, timed codes, and other such techniques are commonly employed. Certain systems employ biometric data for login for access, such as fingerprints, handprints, retinal scans, and so forth. The nature of the technique used, and the degree of security required will typically depend upon the nature of the system itself and the requirements of secrecy.

In a medical diagnostics field, for example, security is becoming increasingly stringent, particularly for systems in which patient identity may be part of a record. Legal and ethical requirements enforce such access control, with secure logins being required to access many records where a patient identification is available. However, because many systems employ various workstations, multiple integrated software packages, and so forth, multiple logins may be required of users. Similarly, users may move from place to place, making multiple logins a necessity. Such logins may require a significant amount of time, a precious commodity to many users, particularly in the medical diagnostic field.

There is a need, at present, for a more powerful login approach which can be used for multiple systems and logins, and which can quickly, but very precisely control authentication and permissions in accessing sensitive systems.

### BRIEF DESCRIPTION OF THE INVENTION

The present invention provides a technique designed to respond to such needs. The technique may be utilized in many areas, but is particularly well-suited to applications in which secure logins are required, as where sensitive information, such as patient information is available. In accordance with aspects of the technique, a wireless device, such as a Bluetooth mobility pin is coupled to a biometric device, such as a thumb scanner or thumbprint scanner. The pin provides for wireless communication with a system to which access is desired. The thumb scanner provides a reliable and secure signal based upon biometric measurements, the signal being provided to the pin. The pin is then uniquely coded to the accessed system. When a workstation or other device having a compatible antenna receives the signal from the pin, the workstation accesses identification data and allows for login of the user based upon the highly secure biometric measurements, and the wireless connection between the pin and the system. The pin will not send the required code unless the coded user of the pin succeeds in scanning the thumbprint or other biometric measurement basis.

### BRIEF DESCRIPTION OF THE DRAWINGS

FIG. 1 is a diagrammatical representation of an exemplary image management system, in the illustrated example a picture archiving and communication system or PACS, for receiving, storing, and reading image data;

FIG. 2 is a diagrammatical representation of an exemplary wireless biometric scanning device, in the illustrated example a wireless thumbprint scanning device;

FIG. 3 is a diagrammatical representation of a user's hand employing the wireless thumbprint scanning device of FIG. 2, the illustrated example showing the user's hand with thumb placed on the fingerprint scanning surface;

FIG. 4 is a diagrammatical representation of an exemplary system interface, in the illustrated example a PACS workstation utilized in the PACS of FIG. 1; and

FIG. 5 is a block diagram of an authentication and log-in method for logging into a controlled-access or secured system and employing a wireless biometric scanning device.

### DETAILED DESCRIPTION OF SPECIFIC EMBODIMENTS

Embodiments of the present technique may incorporate a combination of a biometric technology, such as biometric thumb scanning, with proximity detection login technology to create secure and efficient login mechanisms. In general, aspects of the technique may be applied to systems requiring, for example, authentication or log-in. In the medical context, such systems may include, for example, image handling systems such as a picture archive and communication system (PACS), information systems such as a hospital information system (HIS), medical imaging systems, and so forth. The present technique may also apply to a variety of systems outside of the medical context.

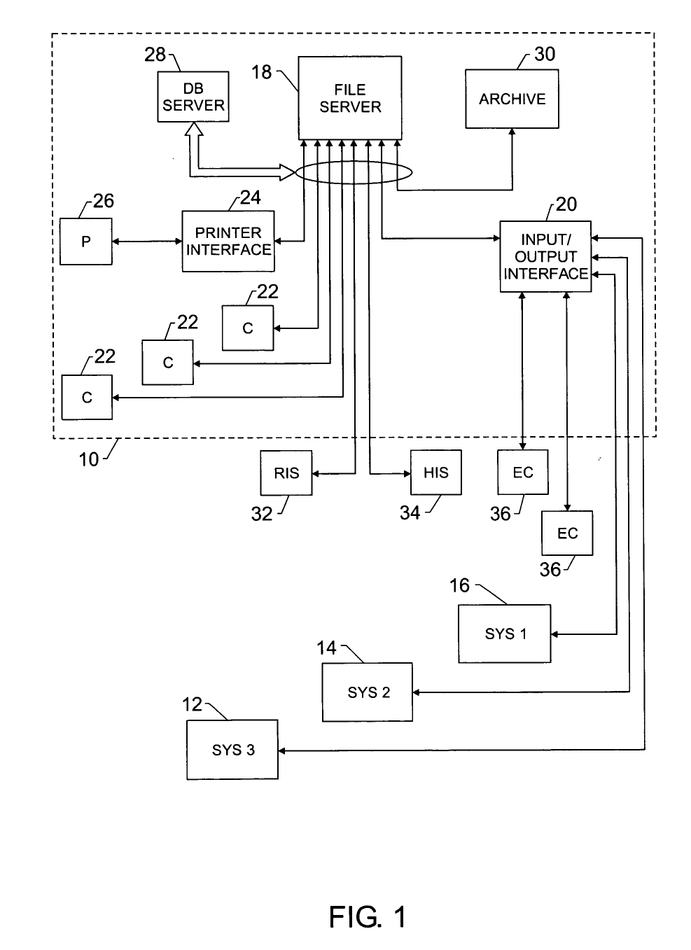

FIG. 1 illustrates an exemplary image data management system in the form of a PACS 10 for receiving, processing, and storing image and other data. In the illustrated embodiment, PACS 10 receives image data from several separate imaging systems designated by reference numerals 12, 14 and 16. As will be appreciated by those skilled in the art, the imaging systems may be of the various types and modalities, such as magnetic resonance imaging (MRI) systems, computed tomography (CT) systems, positron emission tomography (PET) systems, radio fluoroscopy (RF), computed radiography (CR), ultrasound systems, and so forth. Moreover, the systems may include processing stations or digitizing stations, such as equipment designed to provide digitized image data based upon existing film or hard copy images. It should also be noted that the systems supplying the image data to the PACS may be located locally with respect to the PACS, such as in the same institution or facility, or may be entirely remote from the PACS, such as in an outlying clinic or affiliated institution. In the latter case, the image data may be transmitted via any suitable network link, including open networks, proprietary networks, virtual private networks, and so forth.

PACS 10 includes one or more file servers 18 designed to receive, process, and/or store image data, and to make the image data available for further processing and review. Server 18 receives the image data through an input/output interface 20, which may, for example, serve to compress the incoming image data, while maintaining descriptive image data available for reference by server 18 and other components of the PACS 10. Where desired, server 18 and/or interface 20 may also serve to process image data accessed through the server 18. The server is also coupled to internal clients, as indicated at reference numeral 22, each client typically including a workstation at which a radiologist, physician, or clinician may access image data from the server and view or output the reconstructed image as desired. Such a reviewing workstation is discussed below, and is an example of an environment in which aspects of the present technique may be implemented. Clients 22 may also input information, such as dictation of a radiologist following review of examination sequences. Similarly, server 18 may be coupled to one or more interfaces, such as a printer interface 24 designed to access image data and to output hard copy images via a printer 26 or other peripheral.

Server 18 may associate image data, and other workflow information within the PACS by reference to one or more database servers 28, which may include cross-referenced information regarding specific image sequences, referring or diagnosing physician information, patient information, background information, work list cross-references, and so forth. The information within database server 28, such as a DICOM database server, serves to facilitate storage and association of the image data files with one another, and to allow requesting clients to rapidly and accurately access image data files stored within the system.

Similarly, server 18 is coupled to one or more archives 30, such as an optical storage system, which serve as repositories of large volumes of image data for backup and archiving purposes. Techniques for transferring image data between server 18, and any memory associated with server 18 forming a short term storage system, and archive 30, may follow any suitable data management scheme, such as to archive image data following review and dictation by a radiologist, or after a sufficient time has lapsed since the receipt or review of the image files. An archive 30 system may be designed to receive and process image data, and to make the image data available for review.

Additional systems may be linked to the PACS, such as directly to server 18, or through interfaces such as interface 20. In the embodiment illustrated in FIG. 1, a radiology department information system or RIS 32 is linked to server 18 to facilitate exchanges of data, typically cross-referencing data within database server 28, and a central or departmental information system or database. Similarly, a hospital information system or HIS 34 may be coupled to server 18 to similarly exchange database information, workflow information, and so forth. Where desired, such systems may be interfaced through data exchange software, or may be partially or fully integrated with the PACS to provide access to data between the PACS database and radiology department or hospital databases, or to provide a single cross-referencing database. Similarly, external clients, as designated at reference numeral 36, may be interfaced with the PACS to enable images to be viewed at remote locations. Again, links to such external clients may be made through any suitable connection, such as wide area networks, virtual private networks, and so forth. Such external clients may employ a variety of interfaces, such as computers or workstations, to process and review image data retrieved from the PACS 10.

Similarly, the one or more clients 22 may comprise a diagnostic workstation to enable a user to access and manipulate images from one or more of the imaging systems either directly (not shown) or via the file server 18. These reviewing workstations (e.g., at client 22) at which a radiologist, physician, or clinician may access and view image data from the server 18 typically include a computer monitor, a keyboard, as well as other input devices, such as a mouse. The reviewing workstation enables the client to view and manipulate data from a plurality of imaging systems, such as MRI systems, CT systems, PET systems, and ultrasound systems.

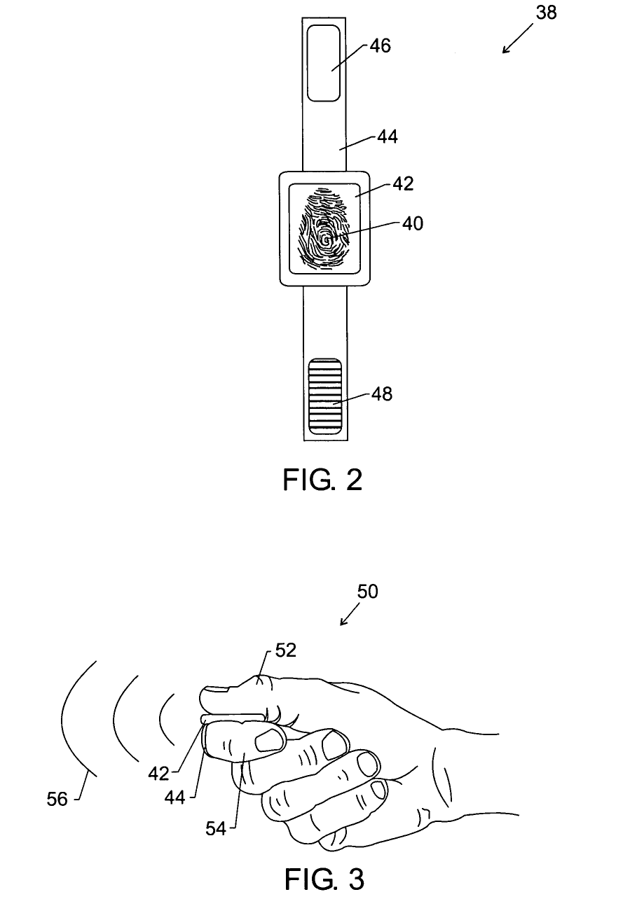

FIG. 2 is a diagrammatical representation of an exemplary wireless biometric device, in this illustration a wireless thumbprint scanner 38 which may be used, for example, by a client 22 or other user to access a controlled-access or secured system, such as the PACS 10 (of FIG. 1) which may require a user to log-in first prior to accessing the system. The device 38 in this example is a combination of a wireless proximity detection device, such as an exemplary Bluetooth mobility pin, coupled to a biometric device, such as an exemplary thumbprint scanner. The exemplary pin provides for wireless communication with a system to which access is desired. The thumbprint scanner provides a reliable and secure signal to the pin based upon biometric measurements. The pin may be uniquely coded to the accessed system, and when a system workstation or other interface having a compatible antenna receives the signal from the pin, the workstation may access identification data and allow for login of the user based upon the highly secure biometric measurements and the wireless connection between the pin and the system.

The present technique may be configured so that the pin will not send required identification code for log-in unless the user of the pin is first authenticated, for example, based on the scanning of a thumbprint or satisfying other biometric measurement bases. A currently preferred embodiment is that the wireless biometric device itself performs authentication of the user desiring access by comparing the user's biometric data, such as a thumbprint, to user biometric or thumbprint data stored within the biometric device 38. As will be appreciated by those skilled in the art, this comparison may involve techniques, such as registration of digital thumbprint data, to authenticate the user. On the other hand, the technique may be configured to engage a system and send biometric data to the system, with the engaged system performing the comparison for authentication prior to log-in. In either case, authentication may involve comparison of biometric measurements of a user to a database of biometric measurements of appropriate users.

Also shown in this example is a band 44 with connectors 46 and 48 for securing the wireless device, such as a wireless thumbprint scanner 38, around a user's finger. It should be noted that the present technique is not limited by the type of biometric scan. Other biometric systems which employ, for example, retinal scans, voice recognition, facial recognition, handprint scans, and so forth, may be utilized in accordance with the present technique. Moreover, the configuration of the wireless device 38, such as having a band 44 with connectors 48 and 48, is only given as an example. A variety of configurations may be employed to facilitate the mobility, ease of use, and the like, with a wireless biometric device, such as the wireless thumbprint scanner 38. In this illustrative embodiment, the user places the thumb over the thumbprint scanner to activate the Bluetooth proximity detection and, if the thumbprint matches, the user is authenticated.

FIG. 3 is a diagrammatical representation of a user hand 50 employing the wireless thumbprint scanning device 38 of FIG. 2, and is a thumbprint scanner integrated with a wireless proximity detection pin. The thumb 52 of the user's hand 50 is placed on the scanning surface 42 to activate the proximity pin to send a signal, if the user is authenticated, to a system interface. In this embodiment, the wireless thumbprint scanning device 38 is secured around the user's forefinger 54 with the band 44. A wireless signal 56 may be received by the system the user is attempting to access. An antenna disposed in the system at an interface, for example, may be configured to receive a wireless communication from a wireless biometric device. A variety of protocols, standards, and types of wireless communications and signals, such as radio, infrared, cable synchronizing, IEEE 802.11a, IEEE 802.11b, IEEE 802.11g, wireless application protocol (WAP), spread-spectrum frequency hopping, half-duplex or full-duplex communication, Bluetooth standards, and so forth, may be applied with the present technique.

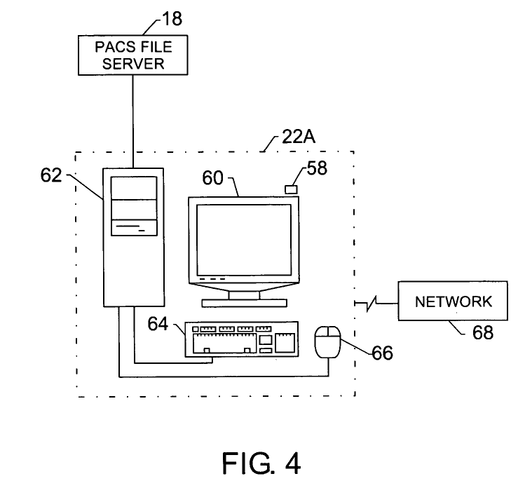

FIG. 4 is a diagrammatical representation of an exemplary system interface generally corresponding to a PACS workstation 22A that may be used by a client 22 to access the PACS 10 illustrated in FIG. 1. An antenna 58 may receive wireless signals 56 from a wireless biometric device, such as the wireless thumbprint scanner 38. The antenna 58 may be wired in the system interface or may communicate wireless itself to the system interface 22A. The PACS workstation 22A and other system interfaces may include, for example, a monitor 60 and a tower 62 housing a hard drive, CPU, memory, and other circuitry. Also included may be a keyboard 64, a mouse 66, and a connection to a network 68 other than the system of interest. In this embodiment, the system of interest is the PACS 10, and the PACS workstation 22 is shown coupled to the PACS file server 18. Again, it is worth reiterating that the present technique is applicable to systems in general having controlled-access, including medical and non-medical secured systems, and is not limited to accessing an exemplary PACS 10.

Medical systems that may employ aspects of the technique include, for example, information systems such as the RIS 32 and HIS 34 mentioned in FIG. 1, as well as, the medical imaging systems 12, 14, and 18 such as an MRI, CT, PET, and so forth, also mentioned in FIG. 1. A user may access information systems via an interface such as the illustrated interface 22A or differently-configured interfaces. Information system interfaces may include, for example, a workstation, general purpose computer, laptop, and the like. Similarly, imaging systems typically have an operator interface similarly configured and the imaging system may require authentication of a user before permitting access by the user. Other medical modality systems, such as electrical resources, typically have operator interfaces and may utilize aspects of the present technique. In general, electrical resource systems may require user-authentication and may incorporate modalities such as electroencephalography (EEG), electrocardiography (ECG or EKG), electromyography (EMG), electrical impedance tomography (EIT), nerve conduction test, electronystagmography resources (ENG), and so forth. Furthermore, medical laboratory and analytical equipment may also typically have operator interfaces and may employ aspects of the present technique. And finally, it should be emphasized that any secured system, such as the typical computer network which may be accessed, for example, on a daily basis by various users, in or out of the medical context, may incorporate aspects of the present technique.

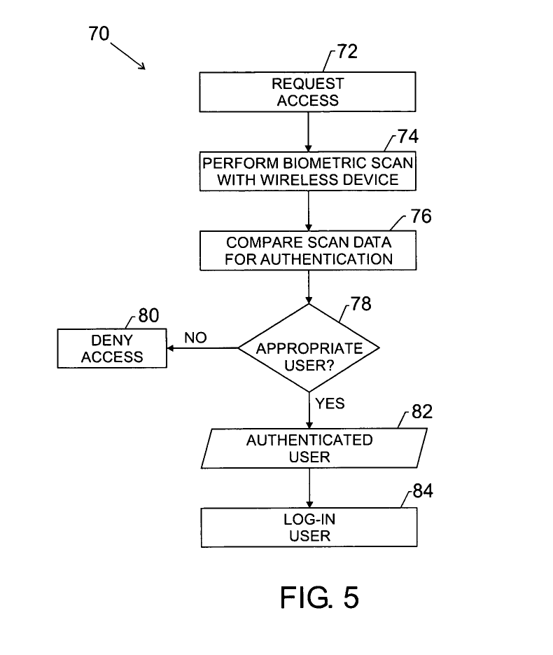

FIG. 5 is a block diagram of an authentication and log-in method 70 for accessing or logging into a secured system and employing a wireless biometric scanning device, such as the wireless thumbprint device 38 illustrated in FIG. 2. Initially, a user may request access to a secured system (block 72). To request access, the user, for example, may engage the secured system by pointing a wireless login device, such as the wireless biometric devices previously discussed, toward an interface of secured system. Such an interface, for example, may employ an exemplary antenna for detecting and receiving a wireless signal from the biometric device. A currently preferred embodiment, however, is that the wireless login device does not transmit any information to the system, including to the system interface or antenna, until the user has been authenticated by the wireless biometric device. With other embodiments, authentication may be performed by the secured system or some other independent system.

In general, prior to authentication and before code is sent from wireless device to the secured system, a biometric scan of the user is performed, as denoted by reference numeral 74. In one example, circuitry within the wireless biometric device 38 is used to compare (block 76) the scan data to stored data to authenticate the user (block 78). For scanned data that does not match the user, no signal is sent to the system and thus the user is denied access, as indicated by block 80. If the scanned data matches the stored data on the user, the user is then authenticated (block 82), a signal with identification information is sent to the system from the wireless device 38, and the user may be logged into the system, as indicated by block 84. It should be noted again, that multiple log-ins at different or the same interface may be accommodated with the technique. For example, a user may need to log into more than one system at a single interface.

One embodiment of the invention utilizes a biometric thumb scanner embedded in a Bluetooth wireless identification pin, which is small enough, for example, to carry in one's pocket or attach to one's coat lapel. Each pin may be uniquely coded to the accessed system. In this embodiment, an interface of the accessed system, such as a PACS workstation, may incorporate a receiver or antenna, such as a Bluetooth antenna, to receive a signal from the wireless biometric device (i.e., thumb scanner with Bluetooth pin). The workstation may then look up that authenticated user's identification information and log that person in, provided no one else was logged in to the system. Again, the technique may be configured such that wireless biometric device, such as the wireless Bluetooth pin with integrated biometric scanner, will not send out user identification code to the system antenna unless the user of that pin succeeds in scanning the thumb print and is first authenticated.

Advantages of the present technique over traditional smart cards, for example, are that if the pin is lost, no one else can use it. In general, the technique provides for secured login, persistent secured login even if the pin or device is lost, and efficient login via proximity detection. A combination of a biometric technology such as biometric thumb scanning with proximity detection login technology creates a secure and efficient login mechanism.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for authentication and log-in to a system, comprising:
performing a biometric scan of a user with a wireless biometric device comprising a wireless proximity detection device coupled to a biometric device;
comparing the biometric scan of the user to stored biometric data to authenticate the user; and
authenticating the user.

2. The method of claim 1, further comprising logging the user into the system.

3. The method of claim 3, further comprising sending a signal to the system from the wireless biometric device to log the user into the system.

4. The method of claim 4, further comprising sending user identification information to a system interface antenna; and comparing the user identification information to an appropriate user database to log the user into the system

5. The method of claim 1, wherein the biometric scan comprises at least one of a thumbprint scan, a fingerprint scan, a handprint scan, a retinal scan, a voice recognition, and a facial recognition.

6. The method of claim 1, wherein the system is a picture and archival communication system (PACS) and an interface of the system is a PACS workstation.

7. The method of claim 1, wherein the system is a medical modality system and the interface of the system is an operator interface of the medical modality system.

8. The method of claim 6, wherein the medial modality system is an imaging system.

9. A method of accessing a system, comprising:
scanning a user with a wireless biometric device;
recognizing biometric measurements of the user and authenticating the user to permit access by the user to the system;
sending a wireless signal to a system device and communicating to the system user identification code; and
logging the user into the system based on the user identification code.

10. The method of claim 9, wherein the system device is an antenna configured to receive a wireless signal.

11. The method of claim 9, further comprising comparing the user identification code to stored identification code data to log the user into the system.

12. The method of claim 9, wherein the biometric device utilizes at least one of a thumbprint scan, a fingerprint scan, a handprint scan, a retinal scan, a voice recognition, and a facial recognition.

13. The method of claim 9, wherein the system is a picture and archival communication system (PACS) and an interface of the system is a PACS workstation.

14. The method of claim 9, wherein the system is a medical modality system and the interface of the system is an operator interface of the medical modality system.

15. A method of logging into a system, comprising:
activating a proximity detection device by satisfying a required biometric measurement;
receiving user identification data from the proximity detection device to the system via a wireless connection; and
logging a user into the system.

16. The method of claim 15, wherein a user is scanned with a biometric device integrated with the wireless proximity detection device to activate the wireless proximity detection device.

17. The method of claim 16, wherein biometric measurements of the user are compared to stored measurement data to authenticate the user, to satisfy the required biometric measurement, and to activate the wireless proximity detection device.

18. The method of claim 16, wherein the biometric device utilizes at least one of a thumbprint scan, a fingerprint scan, a handprint scan, a retinal scan, a voice recognition, and a facial recognition.

19. The method of claim 15, wherein the system is a picture and archival communication system (PACS) and an interface of the system is a PACS workstation.

20. An authentication and log-in system for accessing a secured system, comprising:
a wireless biometric device comprising a wireless proximity detection pin coupled to a biometric device;
a sensor disposed in the biometric device for performing a biometric measurement of a user;
a processing module disposed within the wireless biometric device for conducting the biometric measurement of a user, authenticating the user, and transmitting a wireless communication of authenticated user identification code to the secured system;
a device disposed in the secured system for receiving the authenticated user identification code; and
a log-in module disposed within the secured system for comparing authenticated user identification code to stored identification code and for logging the user into the secured system.

21. The system of claim 20, wherein the biometric device is at least one of a thumbprint scanner, a fingerprint scanner, a handprint scanner, a retinal scan, a voice recognition device, and a facial recognition device.

22. The system of claim 20, wherein the system is a picture and archival communication system (PACS) and an interface of the system is a PACS workstation.

23. A system for authentication and log-in to a system, comprising:
means for performing a biometric scan of the user with a wireless biometric device comprising a wireless proximity detection device coupled to a biometric device;
means for comparing the biometric scan of the user to stored biometric data to authenticate the user; and
means for authenticating the user.

24. A system of accessing a system, comprising:
means for scanning a user with a wireless biometric device;
means for recognizing biometric measurements of the user and authenticating the user to permit access by the user to the system;
means for sending a wireless signal to a system device and communicating to the system user identification code; and
means for logging the user into the system based on the user identification code.

25. A system of logging into a system, comprising:
means for detecting proximity of a user by satisfying a required biometric measurement;
means for receiving user identification data from the detecting means to the system via a wireless connection; and
means for logging a user into the system.

26. A computer program for authentication and log-in to a system, comprising:
at least one computer readable medium; and
computer readable codes stored on the at least one medium for performing a biometric scan of the user with a wireless biometric device comprising a wireless proximity detection device coupled to a biometric device, comparing the biometric scan of the user to stored biometric data to authenticate the user, and authenticating the user.

27. A computer program for authentication and log-in to a system, comprising:
at least one computer readable medium; and
computer readable codes stored on the at least one medium for scanning a user with a wireless biometric device, recognizing biometric measurements of the user and authenticating the user to permit access by the user to the system, sending a wireless signal to a system device and communicating to the system user identification code, and logging the user into the system based on the user identification code.

28. A computer program for authentication and log-in to a system, comprising:
at least one computer readable medium; and
computer readable codes stored on the at least one medium for activating a proximity detection device by satisfying a required biometric measurement, receiving user identification data from the proximity detection device to the system via a wireless connection, and logging a user into the system.
